(19) United States
(12) Patent Application Publication
(10) Pub. No.: US 2025/0284441 A1
(43) Pub. Date: Sep. 11, 2025

(54) IMAGE FORMATION APPARATUS, METHOD FOR THE IMAGE FORMATION APPARATUS, AND RECORDING MEDIUM

(71) Applicant: CANON KABUSHIKI KAISHA, Tokyo (JP)

(72) Inventor: TAKAFUMI SUZUKI, Kanagawa (JP)

(21) Appl. No.: 19/065,971

(22) Filed: Feb. 27, 2025

(30) Foreign Application Priority Data
Mar. 8, 2024 (JP) 2024-035727

(51) Int. Cl. G06F 3/12

(52) U.S. Cl. CPC G06F 3/1238; G06F 3/1222

(57) ABSTRACT

Provided is an image formation apparatus including a reading unit configured to read a sheet on which a character string is printed, and a memory storing a program and a processor, when executing the program, configured to extract the character string from the read sheet, generate, based on the extracted character string, login information for logging into the image formation apparatus, and register the generated login information.

### BACKGROUND

### Field

The present disclosure relates to an image formation apparatus, a method for the image formation apparatus, and a recording medium.

### Description of the Related Art

Personal information of a user who uses an image formation apparatus is registered by operating a touch panel of the image formation apparatus. When the image formation apparatus is to be used, an authentication is performed to use a function of the image formation apparatus. As a user registration method in a multi-functional peripheral, Japanese Patent Laid-Open No. 2005-335215 describes registration of a user in an address book by the user from an operation panel of the multi-functional peripheral.

According to the above-described technique, registration of user information that is necessary to use the apparatus needs to be performed by the user via an operation unit. The registration of the user information by the user involves large operational burden, and an operational error may occur.

### SUMMARY

An image formation apparatus according to an aspect of the present disclosure includes a reading unit configured to read a sheet on which a character string is printed, and a memory storing a program and a processor, when executing the program, configured to extract the character string from the read sheet, generate, based on the extracted character string, login information for logging into the image formation apparatus, and register the generated login information.

Further features of the present disclosure will become apparent from the following description of exemplary embodiments with reference to the attached drawings.

### BRIEF DESCRIPTION OF THE DRAWINGS

FIG. 1 illustrates a configuration of an entire printing system according to a first embodiment of the present disclosure.

FIG. 2 illustrates a hardware configuration of a client terminal according to the first embodiment of the present disclosure.

FIG. 3 illustrates a hardware configuration of an image formation apparatus according to the first embodiment of the present disclosure.

FIG. 4 illustrates a software configuration of the entire printing system according to the first embodiment of the present disclosure.

FIG. 5 illustrates a flowchart of user registration processing of the image formation apparatus according to the first embodiment of the present disclosure.

FIG. 6 illustrates descriptions of an identification certificate according to the first embodiment of the present disclosure.

FIG. 7 illustrates a software configuration of the entire printing system according to a second embodiment of the present disclosure.

FIG. 8 illustrates descriptions of a registration job according to the second embodiment of the present disclosure.

FIG. 9 illustrates a sequence of the entire printing system according to the second embodiment of the present disclosure.

FIG. 10 illustrates a flowchart of provisional registration processing of the image formation apparatus according to a third embodiment of the present disclosure.

FIG. 11 illustrates a flowchart of formal registration processing of the image formation apparatus according to the third embodiment of the present disclosure.

FIG. 12 illustrates a flowchart of user information update processing of the image formation apparatus according to a fourth embodiment of the present disclosure.

FIG. 13 illustrates descriptions of the registration job according to a fifth embodiment of the present disclosure.

FIG. 14 illustrates a sequence of the entire printing system according to the fifth embodiment of the present disclosure.

FIG. 15 illustrates a flowchart of user information registration processing of the image formation apparatus which has received user information according to the fifth embodiment of the present disclosure.

FIG. 16 illustrates a flowchart of the user information registration processing of the image formation apparatus according to a sixth embodiment of the present disclosure.

### DESCRIPTION OF THE EMBODIMENTS

Each embodiment of the present disclosure will be described with reference to the attached drawings. The following embodiments are not intended to be limiting, and not all combinations of features described in the respective embodiments are necessarily essential.

### First Embodiment

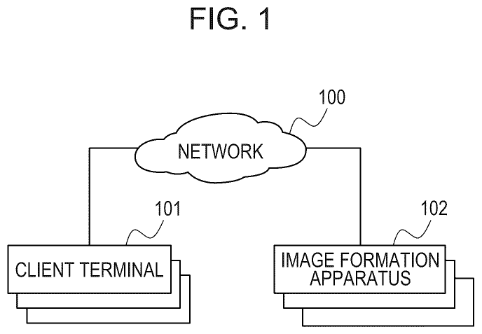

FIG. 1 is a system configuration diagram illustrating an entire printing system according to a first embodiment of the present disclosure.

A client terminal 101 has a function of issuing an execution instruction such as printing or scanning to an image formation apparatus 102 by using a browser or the like. A personal computer or a mobile terminal is assumed as the client terminal 101, but the type of the client terminal 101 is not limited.

The image formation apparatus 102 has a scanning function with which image data can be obtained from a recording medium placed on the image formation apparatus 102. The image formation apparatus 102 also has a user management function of authenticating a user of the image formation apparatus 102 to impose a use restriction of the function such as printing or scanning.

One or a plurality of client terminals 101 and one or a plurality of image formation apparatuses 102 are connected to each other via a network 100.

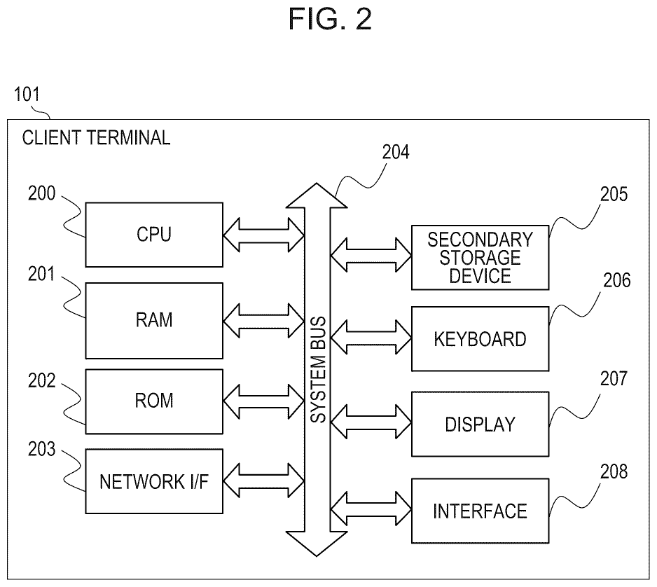

FIG. 2 illustrates a hardware configuration of the client terminal 101 according to the first embodiment of the present disclosure.

A central processing unit (CPU) 200 controls the client terminal 101. The CPU 200 executes a program stored in a ROM 202 or a secondary storage device 205 and temporarily stores information used to execute the program in a RAM 201. The random access memory (RAM) 201 is a storage unit and temporarily stores information used to execute the program. The read only memory (ROM) 202 is a storage unit and stores various data such as a basic I/O program therein.

A network I/F (interface) 203 enables the client terminal 101 to communicate with the other client terminal 101 or the image formation apparatus 102. A communication method supports both wired communication and wireless communication. A system bus 204 connects each element in the client terminal 101 and propagates a control command from the CPU 200 across the client terminal 101. The secondary storage device 205 is an external storage unit and functions as a large volume memory. The secondary storage device 205 includes a hard disk drive (HDD), a flash memory, or the like and stores a program or the like of a web browser or a service server group.

A keyboard 206 is an instruction input unit. A display 207 is a display unit, and when the display 207 is connected to the image formation apparatus 102, setting information associated with the image formation apparatus 102 can be browsed. An interface 208 is an external apparatus I/F and enables connection to the image formation apparatus 102 or a peripheral such as a USB device.

The above-described configuration is an example of the present embodiment and is not limited to the configuration example illustrated in FIG. 2. For example, the RAM 201 can be designated as a storage destination of the program, and the program can be executed by the CPU 200.

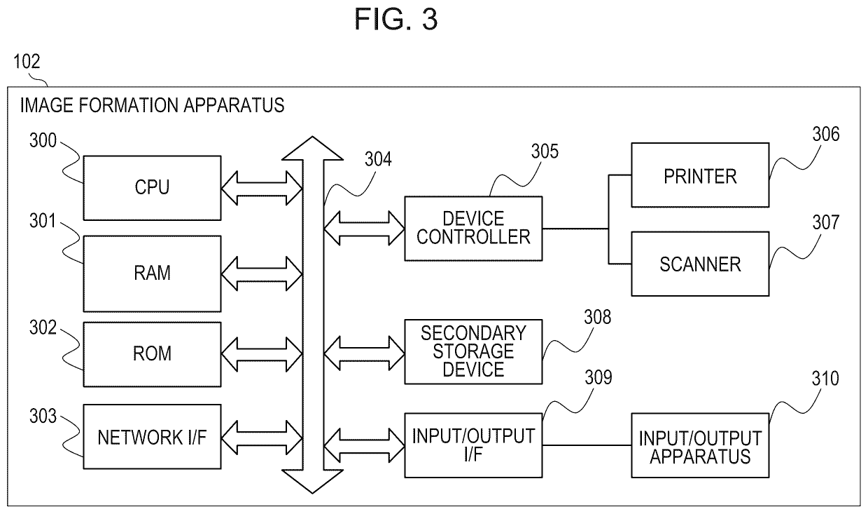

FIG. 3 illustrates a hardware configuration of the image formation apparatus 102 according to the first embodiment of the present disclosure.

A central processing unit (CPU) 300 controls the image formation apparatus 102. The CPU 300 executes a program stored in a ROM 302 or a secondary storage device 308 and temporarily stores information used to execute the program in the RAM 301. The random access memory (RAM) 301 is a storage unit and temporarily stores information used to execute the program. The read only memory (ROM) 302 is a storage unit and stores various data such as a basic I/O program therein.

A network I/F 303 enables the image formation apparatus 102 to communicate with the client terminal 101 or the other image formation apparatus 102. A communication method supports both wired communication and wireless communication.

A system bus 304 connects each element in the image formation apparatus 102 and propagates a control command from the CPU 300 across the image formation apparatus 102. A device controller 305 controls a device such as a printer 306 or a scanner 307 based on the control command received from the CPU 300.

The printer 306 executes a printing job. The scanner 307 executes scanning of the recording medium placed on the image formation apparatus 102. A hard disc drive (HDD) or a flash memory is applicable as the secondary storage device 308. With an input/output I/F 309, a signal received from an input/output apparatus 310 is transferred to each element in the image formation apparatus 102.

The input/output apparatus 310 represents a plurality of configurations that perform input and output operations in the image formation apparatus 102. Specifically, the input/output apparatus 310 includes a touch panel, a hard key, and the like, and accepts an input from the user to transmit a signal corresponding to the input to each element in the image formation apparatus 102 via the input/output I/F 309.

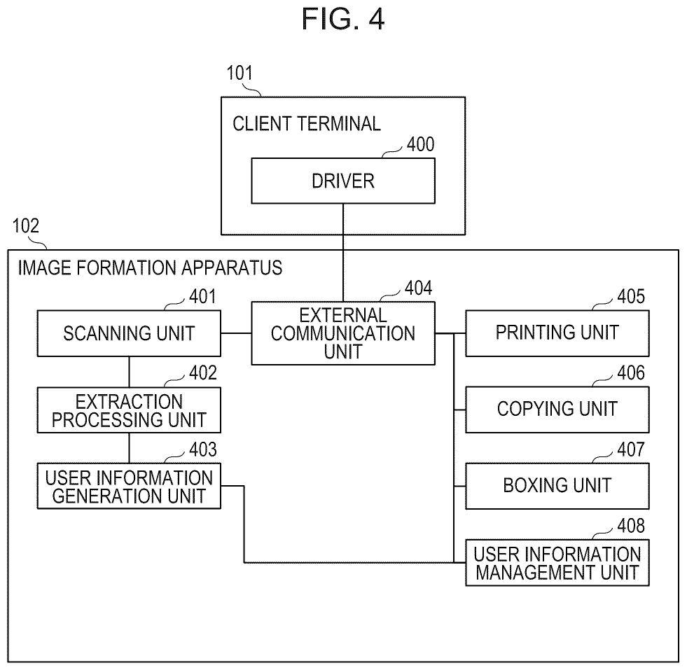

FIG. 4 illustrates a software configuration according to the present embodiment. A driver 400 is a function included in the client terminal 101. The driver 400 generates a job for controlling the image formation apparatus 102 and transmits the job to the image formation apparatus 102 via the network I/F 203 to enable operation of the image formation apparatus 102.

A scanning unit 401 scans an identification certificate placed on the image formation apparatus 102 to obtain image data of the identification certificate. The scanning unit 401 executes scanning when the scanner 307 operates based on the job transmitted from the driver 400 or the signal transmitted from the input/output apparatus 310.

An extraction processing unit 402 subjects the image data obtained by the scanning unit 401 to optical character reader (OCR) processing to obtain text information included in the image data. The extraction processing unit 402 then obtains a predetermined character string from the text information. Specifically, the predetermined character string includes a name, a personal number, date information indicating an expiry, or the like. The processing of obtaining the text information from the image data may be a processing other than the OCR processing.

A user information generation unit 403 generates user information used to log into the image formation apparatus 102 using predetermined character strings obtained by the extraction processing unit 402. Specifically, the user information generation unit 403 selects one of the predetermined character strings as a user ID and another character string as an initial password to generate user information in which a combination of the user ID and the initial password is stored. The user information generation unit 403 also attaches a hash value to the user information to uniquely identify the user information. When the generation of the user information is completed, the user information generation unit 403 stores the generated user information in the secondary storage device 308.

An example of the user information (login information) generated by the user information generation unit 403 is illustrated in Table 1.

TABLE 1
User information

| User ID | Password | HashKey |
|---|---|---|
| Shimomaruko Taro | 110100197810270022 | 12345abcdef |

A “user ID” column stores a value for identifying a user of the image formation apparatus 102. In the case of this example, the user information generation unit 403 selects, as a first character string, information relevant to the name from the text information obtained by the extraction processing unit 402 to be set as a value in the column of the “user ID”.

A “password” column stores an initial value of the password that is used by a person whose data is printed on the identification certificate to log into the image formation apparatus 102. In the case of this example, the user information generation unit 403 selects, as a second character string, information relevant to the personal number with which the person whose data is printed on the identification certificate can be uniquely identified from the text information obtained by the extraction processing unit 402 to be set as a value in the “password” column. It is noted that the value in the “password” column is not limited to the personal number described on the identification certificate. For example, other information described on the identification certificate such as a date of expiry of the identification certificate may be used.

A “HashKey” column stores a hash value for uniquely identifying the user information.

The user of the image formation apparatus 102 can log into the image formation apparatus 102 by inputting the values in the “user ID” column and the “initial password” column from the input/output apparatus 310.

An external communication unit 404 communicates with the client terminal 101 to receive the job generated by the driver 400. Thus, the image formation apparatus 102 causes the scanning unit 401, a printing unit 405, a copying unit 406, and a boxing unit 407 to operate according to content of the received job to provide each function of the image formation apparatus 102 to the user.

A user information management unit 408 refers to the secondary storage device 308 to manage all the user information in Table 1 as a “user table”. The user information management unit 408 performs login processing to the image formation apparatus 102, display of the user information described in Table 1 via the input/output apparatus 310, and set value alteration processing by using the user table. An example of the user table is illustrated in Table 2.

TABLE 2
User table

| User ID | Password | HashKey |
|---|---|---|
| Shimomaruko Taro | 110100197810270022 | 12345abcdef |
| Shimomaruko Hanako | 110100197810270023 | 67890uvwxyz |

Each column in the user table is equivalent to each column of the user information in Table 1, and the description thereof is not provided herein.

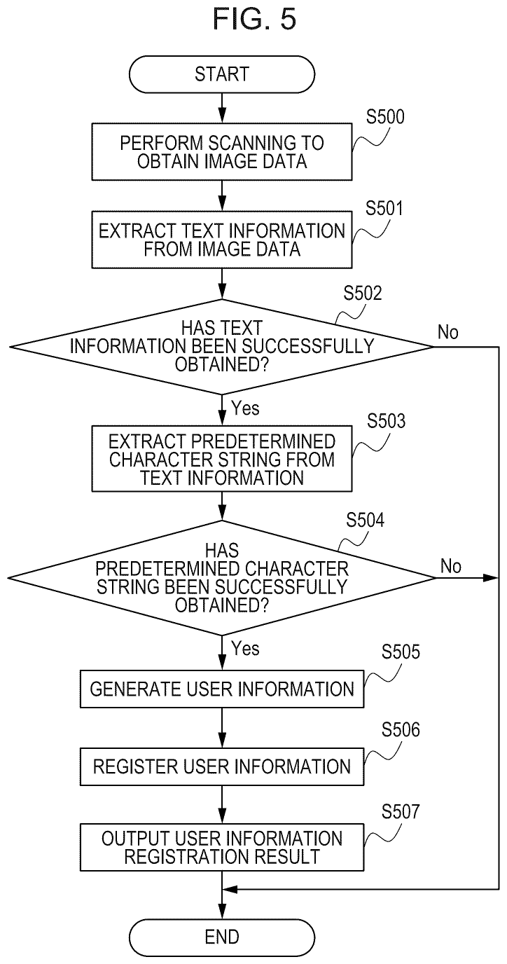

FIG. 5 illustrates a flowchart of user registration processing of the image formation apparatus 102 according to the present embodiment. The flowchart in FIG. 5 is realized when the CPU 300 of the image formation apparatus 102 reads out a program for realizing the features of the flowchart in FIG. 5 stored in the ROM 302 or the secondary storage device 308 onto the RAM 301 to execute the program. A process flow in FIG. 5 is started when the scanning unit 401 is activated by a signal originating from the input/output apparatus 310 or a scanning instruction transmitted from the driver 400.

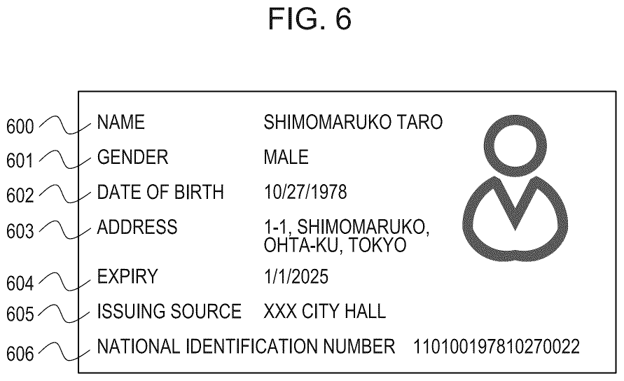

In S500, the scanning unit 401 scans (reads) a sheet (for example, an identification certificate) on which a character string is printed and which is placed on the scanner 307 to obtain image data. In S501, text information is extracted from the image data obtained in S500 by the extraction processing unit 402. The text information to be extracted will be described with reference to FIG. 6.

FIG. 6 illustrates an example of the identification certificate to be scanned by the image formation apparatus 102 according to the present embodiment.

Name 600 indicates a name of an owner of the identification certificate. Gender 601 indicates a gender of the owner of the identification certificate, including an option other than male or female (for example, other). Date of birth 602 indicates a date of birth of the owner of the identification certificate. Address 603 indicates an address of the owner of the identification certificate. Expiry 604 is date information indicating an expiry of the identification certificate. A format of the date information is not limited to the example illustrated in FIG. 6. For example, the format can also include a format “YYYYMMDDThhmmss” defined in accordance with ISO 8601.

Issuing source 605 indicates an issuer of the identification certificate. National identification number 606 is a number uniquely allocated to the owner of the identification certificate. The information is not limited to the national identification number as long as the information is described on the identification certificate subjected to scanning and is uniquely allocated to the owner of the identification certificate. For example, an employee number may be used in the case of an employee identification certificate indicating affiliation to a company.

A language display of the information from the name 600 to the national identification number 606 is not limited.

The description will now return to FIG. 5.

It is assumed that the text information to be extracted in S501 includes all pieces of character information described on the identification certificate from the name 600 to the national identification number 606 in FIG. 6.

In S502, it is determined whether the text information has been successfully extracted by the extraction processing unit 402 in S501. When it is determined that the text information has been successfully extracted, in other words, when the information of at least one of the name 600 to the national identification number 606 has been successfully extracted, the process flow transitions to step S503. When the text information has not been successfully extracted, in other words, none of the information from the name 600 to the national identification number 606 has been extracted, the process flow in FIG. 5 ends.

In S503, a character string to be used to generate the user information described in Table 1 is extracted from the text information generated in S501 by the extraction processing unit 402. Specifically, the extraction processing unit 402 extracts, from the text information, the information relevant to the name 600 as the first character string and the information relevant to the national identification number 606 or the expiry 604 as the second character string.

In S504, it is determined whether both the character strings of the first character string and the second character string have been successfully extracted by the extraction processing unit 402 in S503. When it is determined that both the character strings have been successfully extracted, the process flow transitions to step S505. When the character strings have not been successfully extracted, the process flow in FIG. 5 ends.

In S505, the user information generation unit 403 generates the user information described in Table 1 by using the first character string and the second character string extracted in S503. Specifically, the user information generation unit 403 allocates the first character string to the value in the “user ID” column and the second character string to the value in the “password” column. The user information generation unit 403 also hashes the second character string to allocate an obtained value to the value in the “HashKey” column.

In S506, the user information generation unit 403 stores the user information described in Table 1 generated in S505 in the secondary storage device 308. The user information may be stored in a storage unit of the client terminal 101. In S507, the input/output apparatus 310 displays the values in the “user ID” column and the “password” column of the user information generated in S505.

The registered user information is used for the user login to the image formation apparatus 102, and the image formation apparatus 102 prints an image associated with a logged-in user.

As described above, based on the flowchart in FIG. 5, the user information can be directly generated based on the information described on the identification certificate. Thus, it is no longer necessary for an administrator of the image formation apparatus 102 to correct an input error of the user information. In addition, since the operation of the input/output apparatus 310 at the time of the user information registration can be kept to a minimum, it becomes possible to efficiently register the user information.

As described above, according to the present embodiment, it is possible to reduce the operational burden on the administrator of the image formation apparatus 102 at the time of the user information registration.

### Second Embodiment

According to the first embodiment, the information described on the identification certificate is extracted to be used as it is for the generation of the user information.

In the first embodiment, since even a person who has not been granted a use permission of the image formation apparatus 102 from the administrator of the image formation apparatus 102 can register the user information, additional instances of the user information may be registered in the image formation apparatus 102. To limit users of the image formation apparatus 102, the administrator of the image formation apparatus 102 needs to register the user information, which may lead to additional work on the part of the administrator in the registration of the user information.

According to a second embodiment, the administrator of the image formation apparatus 102 creates a job for activating the process flow described in FIG. 5, and a user who has been granted permission from the administrator can perform the registration of the user information by using the job.

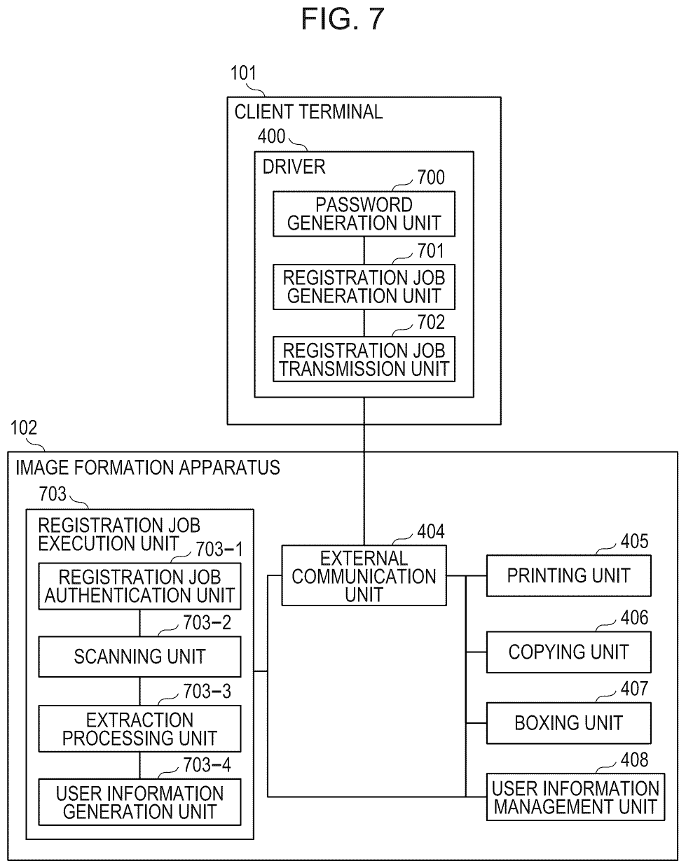

FIG. 7 illustrates a software configuration according to the present embodiment. The external communication unit 404, the printing unit 405, the copying unit 406, the boxing unit 407, and the user information management unit 408 are equivalent to the functions described in FIG. 4 corresponding to the respective reference numerals, and thus the description thereof is not repeated herein.

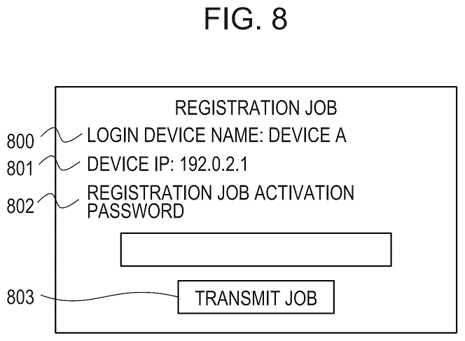

A password generation unit 700, a registration job generation unit 701, and a registration job transmission unit 702 are functions included in the driver 400. The password generation unit 700 generates a password for activating a job (hereinafter, a registration job) for executing the process flow illustrated in FIG. 5. There is no restriction on a format of a value of the password generated by the password generation unit 700. The registration job generation unit 701 generates a registration job. The registration job will be described in detail with reference to FIG. 8.

FIG. 8 illustrates an example of a setting screen of the registration job that is displayed on the display 207. Login device name 800 displays a name of the image formation apparatus 102 configured to execute the registration job. Device IP 801 displays an IP address of the image formation apparatus 102 configured to execute the registration job.

Registration job activation password 802 inputs the password for activating the registration job in the image formation apparatus 102. Job transmission button 803 is a button for transmitting the registration job to the image formation apparatus 102 displayed under the login device name 800. Job transmission button 803 can be selected in a case where the password is input to an input field of the registration job activation password 802.

The description will now return to FIG. 7.

In a case where the password has been set in the registration job activation password 802 and the job transmission button 803 has been selected, the registration job transmission unit 702 transmits the registration job to the image formation apparatus 102 described under the login device name 800. The registration job is transmitted to a registration job execution unit 703 via the external communication unit 404.

Registration job execution unit 703 is a function for executing the registration job received from the registration job transmission unit 702. Registration job execution unit 703 includes a registration job authentication unit 703-1, a scanning unit 703-2, an extraction processing unit 703-3, and a user information generation unit 703-4.

The registration job authentication unit 703-1 performs an authentication to activate the registration job. In a case where content that has been input by the input/output apparatus 310 matches a password that has been set in the registration job activation password 802, the registration job authentication unit 703-1 permits a use of the registration job. When the use of the registration job is permitted, a person who desires to use the image formation apparatus 102 scans the identification certificate by the scanning unit 703-2 to be allowed to perform the registration of the user information via the extraction processing unit 703-3 and the user information generation unit 703-4.

The scanning unit 703-2, the extraction processing unit 703-3, and the user information generation unit 703-4 are respectively similar to the scanning unit 401, the extraction processing unit 402, and the user information generation unit 403, and thus the description thereof is not repeated herein.

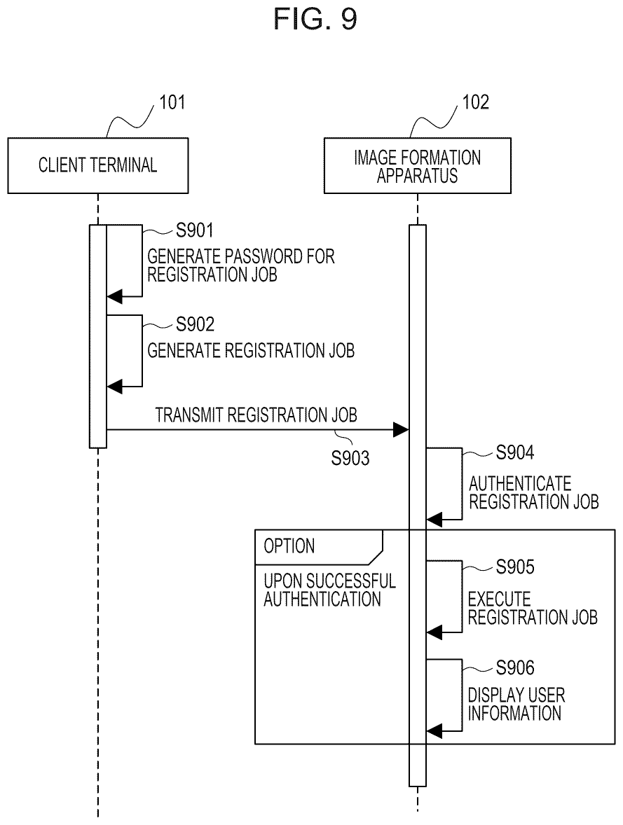

FIG. 9 illustrates a process sequence of the entire print system according to the present embodiment.

Steps S901 to S903 are started when the driver 400 has been activated in the client terminal 101.

In S901, the password generation unit 700 generates a password to be attached to the registration job. In S902, the registration job generation unit 701 generates the registration job described in FIG. 8. In S903, the registration job transmission unit 702 transmits the registration job generated in S902 to the image formation apparatus 102 described under the login device name 800.

Steps S904 and S905 are started when the image formation apparatus 102 has received the registration job from the client terminal 101.

In S904, the registration job authentication unit 703-1 of the registration job execution unit 703 performs an authentication for activating the registration job. In a case where the value input from the input/output apparatus 310 matches the password set in the registration job, the registration job authentication unit 703-1 activates the registration job, and the process flow transitions to S905. In a case where the value is mismatched with the password, the process flow in FIG. 9 ends.

In S905, the registration job execution unit 703 executes the registration job to generate the user information from the information described on the identification certificate. In S905, steps S500 to S506 are executed.

In S906, the input/output apparatus 310 displays the user information generated in S905.

As described above, based on the sequence diagram in FIG. 9, the user who has obtained the password from the administrator of the image formation apparatus 102 can perform the registration of the user information in the image formation apparatus 102 themselves. In other words, some of the user information registration operation can be delegated to the user who desires to use the image formation apparatus 102. In addition, since only the user who has been granted the permission from the administrator of the image formation apparatus 102 registers the user information, it is possible to avoid registration of unnecessary user information.

As described above, according to the present embodiment, the operational burden on the administrator of the image formation apparatus 102 in the user registration operation can be reduced.

### Third Embodiment

In the first embodiment, the user information is created based on the information extracted from the identification certificate to be registered in the image formation apparatus 102.

In the first embodiment, additional instances of user information may be registered. For example, there can be a case where the registration of the user information has been performed, but thereafter, no login has been made to the image formation apparatus 102. In such a case, the administrator of the image formation apparatus 102 performs an authority setting for the user information that is not to be used and delete the user information, which may result in additional work on the part of the administrator of the image formation apparatus 102 increases.

According to a third embodiment, at the time of new registration of user information, the user information is put into a provisionally registered state, and when the user logs into the image formation apparatus 102 for the first time, an initial password of the user information is changed and then formal registration is performed. Based on this, according to the third embodiment, the input/output apparatus 310 is caused to display only the formally registered user information.

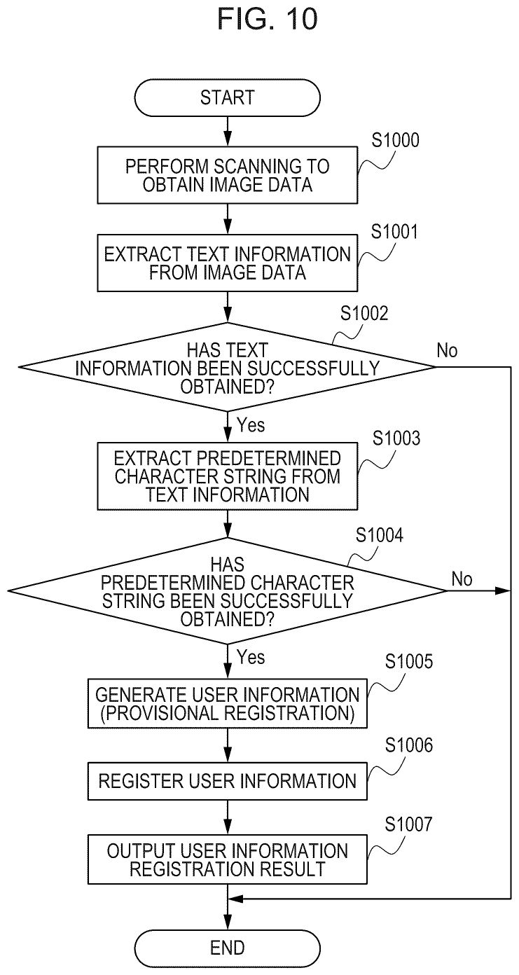

FIG. 10 illustrates a flowchart of provisional registration processing of the user information according to the present embodiment.

A realization method and a start condition for the flowchart in FIG. 10 is similar to those for the flowchart in FIG. 5, and the description thereof is not repeated herein. Steps S1000 to S1004 are equivalent to steps S500 to S504, and the description thereof is not repeated herein. In S1005, the user information generation unit 403 generates the user information. At this time, the user information generation unit 403 attaches a parameter indicating a registration state to the user information. An example of the user information generated in S1005 is illustrated in Table 3.

TABLE 3
User information with status

| User ID | Password | Status |
|---|---|---|
| Shimomaruko Taro | 110100197810270022 | Provisional |

The “user ID” column is equivalent to the “user ID” column of the user information described in Table 1, and the description thereof is not repeated herein. The “password” column is a column for storing a password to be used at the time of login to the image formation apparatus 102. In S1005, the national identification number 606 or the expiry 604 is stored in this column as the initial password.

A “status” column is a column for storing a value indicating a registration state of the user information. In a case where the value is “Provisional”, the user information is in the provisionally registered state. In a case where the value is “Active”, the user information is in a formally registered state. Only the user information with the value of “Active” is displayed on the input/output apparatus 310 and subjected to a management such as a set value alteration via the user information management unit 408.

Steps S1006 and S1007 are equivalent to steps S506 and S507, and the description thereof is similarly not repeated herein. In S1006, when the user logs into the image formation apparatus, the user information is registered.

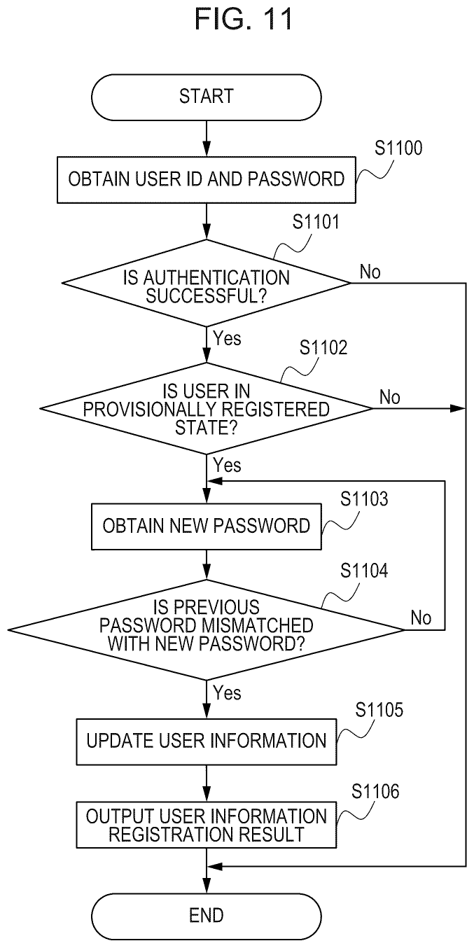

FIG. 11 illustrates a flowchart of formal registration processing of the user information according to the present embodiment. Steps S1100 to S1106 are executed when the user information management unit 408 has received a signal associated with the login processing from the input/output apparatus 310. In S1100, the user information management unit 408 obtains the user ID and the password for logging into the image formation apparatus 102 from the input/output apparatus 310.

In S1101, the user information management unit 408 authenticates the login user. In a case where a combination of the user ID and the password received in S1100 matches a combination of the values in the “user ID” column and the “password” column that are described in the user information with status in Table 3, it is determined that the authentication is successful, and the process flow transitions to step S1102. In a case where the combinations of the user ID and the password are not matched with each other, in other words, a case where the authentication has failed, the process flow in FIG. 11 ends.

In S1102, the status of the user information authenticated in S1101 by the user information management unit 408 is checked. In a case where the value in the “status” column of the user information with status in Table 3 is “Provisional”, in other words, a case where the user information is in the provisionally registered state, the process flow transitions to step S1103. In a case where the value in the “status” column is “Active”, the process flow in FIG. 11 ends.

In S1103, the user information management unit 408 obtains a new password via the input/output apparatus 310. In S1104, the user information management unit 408 determines whether the password set in the user information with status is mismatched with the password obtained in S1103. When it is determined that the passwords are mismatched with each other, the process flow in FIG. 11 transitions to step S1105. When it is determined that the passwords are matched with each other, the process flow returns to step S1103.

In S1105, the user information management unit 408 performs update processing of the user information with status. The value in the “password” column of the user information with status is updated to the password obtained in S1103. The value in the “status” column of the user information with status is updated to “Active”.

In S1106, the input/output apparatus 310 displays the user information on which the update processing has been performed in S1105. The input/output apparatus 310 displays the user ID of the user information and the new password updated in S1105.

As described above, based on the flowcharts in FIG. 10 and FIG. 11, only the user who actually uses the image formation apparatus 102 can be subjected to the user information management by the administrator of the image formation apparatus 102.

As described above, according to the present embodiment, the load of the user information management operation on the administrator of the image formation apparatus 102 can be reduced.

### Fourth Embodiment

In the first embodiment, user information is newly created based on the information extracted from the identification certificate to be registered in the image formation apparatus 102.

In the first embodiment, the information of the identification certificate of the user is updated to implement the registration of the user information by scanning the identification certificate again such that both the new user information and the old user information are registered in the image formation apparatus 102. To delete the old user information, the administrator of the image formation apparatus 102 operates the image formation apparatus 102. The administrator of the image formation apparatus 102 can change the setting of the registered user information via the user information management unit 408. Updating the identification certificate may result in additional work on the part of the administrator of the image formation apparatus 102.

According to a fourth embodiment, update of the user information is enabled in a case where the information described on the identification certificate is updated.

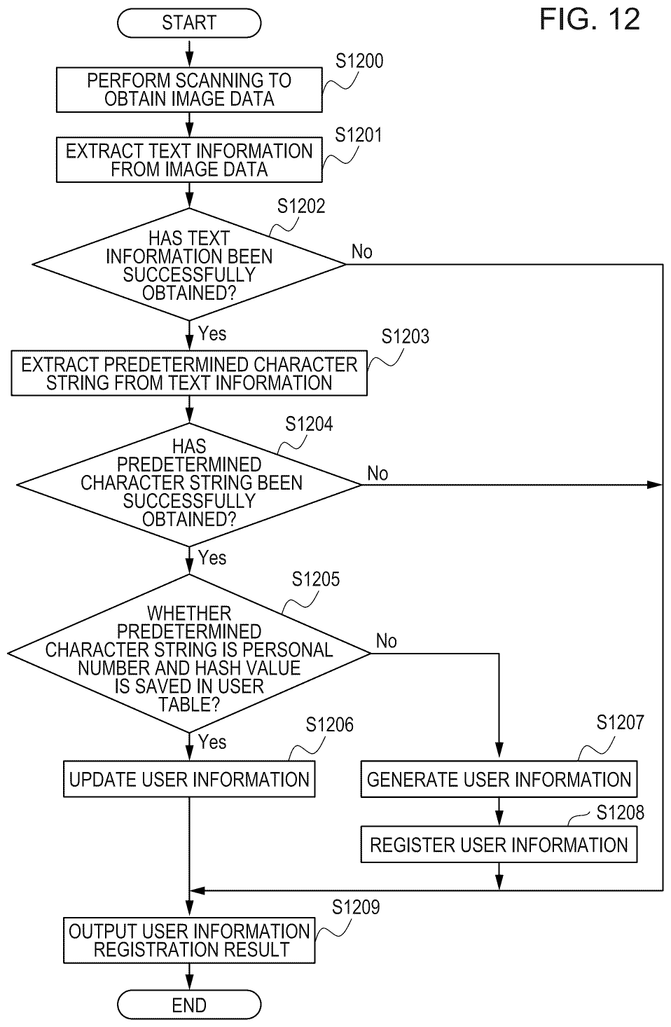

FIG. 12 illustrates a flowchart of user information update processing of the image formation apparatus 102 according to the present embodiment. A realization method and a start condition for the flowchart in FIG. 12 are similar to those for the flowchart in FIG. 5, and the description thereof is not repeated herein.

Steps S1200 to S1204 are equivalent to steps S500 to S504, and the description thereof is not repeated herein.

In S1205, the user information generation unit 403 determines whether an owner of the identification certificate scanned in S1200 is registered in the image formation apparatus 102 as the user. Specifically, the user information generation unit 403 accesses the user table of Table 2 stored by the user information management unit 408. Thereafter, the user information generation unit 403 searches the “HashKey” column in the user table to attempt to obtain the user information in Table 1 having the same value as the hash value of the national identification number 606 extracted in S1203. In a case where the user information has been successfully obtained, the process flow transitions to step S1206. In a case where the user information has not been successfully obtained, the process flow transitions to step S1207.

In S1206, the user information generation unit 403 implements an update of the user information in Table 1. Specifically, the user information generation unit 403 replaces the value in the “user ID” column of the user information in Table 1 with the character string relevant to the name 600 obtained in S1203.

Steps S1207 and S1208 are equivalent to steps S505 and S506, and the description thereof is not repeated herein.

In S1209, the input/output apparatus 310 displays the values in the “user ID” column and the “password” column of the user information. Specifically, in a case where the process flow transitions from S1206 to S1209, the input/output apparatus 310 displays the new name 600 and the unchanged password. In a case where the process flow transitions from S1208 to S1209, the input/output apparatus 310 displays the name 600 and the national identification number 606 or the expiry 604.

As described above, based on the flowchart in FIG. 12, the update processing of the user information can be implemented by scanning the identification certificate.

As described above, according to the present embodiment, it is possible to reduce the operational burden on the administrator of the image formation apparatus 102 at the time of the update of the information of the identification certificate.

### Fifth Embodiment

In the second embodiment, by introducing the job for activating the process flow described in FIG. 5, the registration operation of the user information is performed by the person who desires to use the image formation apparatus 102.

In the second embodiment, a plurality of image formation apparatuses 102 are configured to register user information, which results in the administrator of the image formation apparatuses 102 issuing the same number of registration jobs of FIG. 8 as the number of image formation apparatuses 102.

User information of the same user may differ between the plurality of image formation apparatuses 102.

According to a fifth embodiment, the registration job is transmitted to a plurality of image formation apparatuses 102, and when the registration job is executed in one of the image formation apparatuses 102, the user information is to be shared with the other image formation apparatus 102.

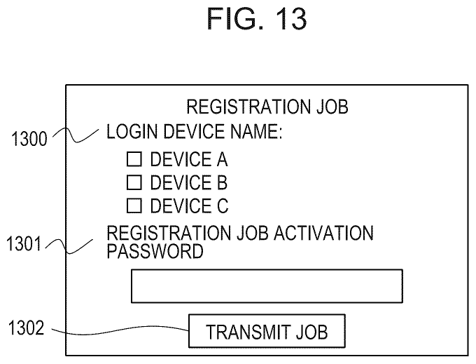

FIG. 13 illustrates an example of the setting screen of the registration job that is displayed on the display 207 according to the present embodiment.

Login device name 1300 is a check box for displaying identification information of one or a plurality of image formation apparatuses 102 that are set as targets to which the registration job is to be transmitted. Thus, the registration job can be transmitted to the plurality of image formation apparatuses 102 at the same time.

Registration job activation password 1301 and job transmission button 1302 are equivalent to the registration job activation password 802 and the job transmission button 803 in FIG. 8, and the description thereof is not repeated herein.

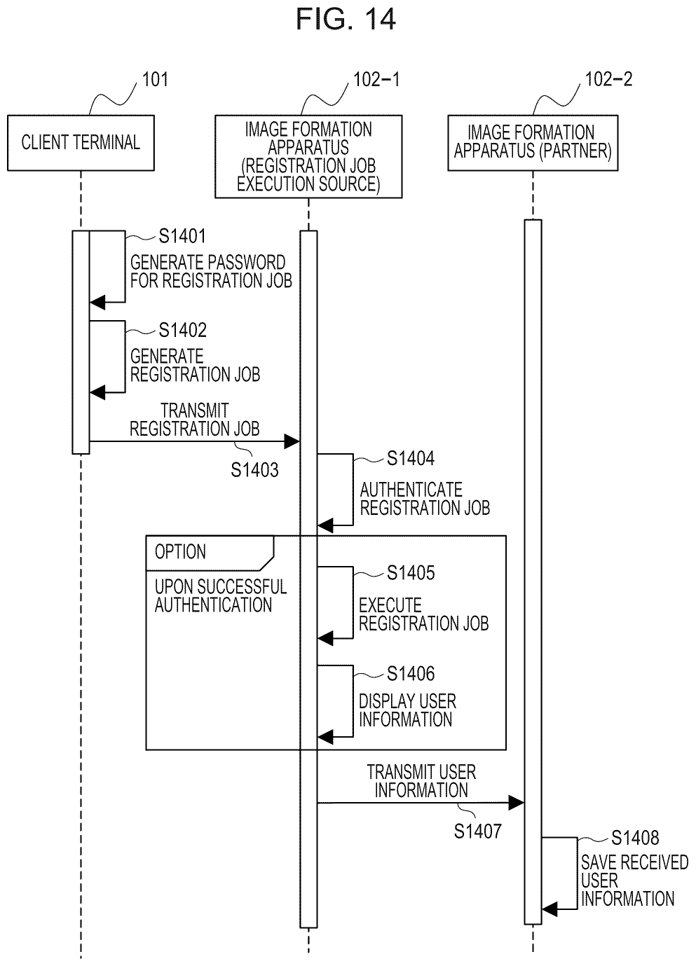

FIG. 14 illustrates an entire sequence according to the present embodiment. Step S1401 is equivalent to step S901, and the description thereof is not repeated herein. In S1402, the registration job generation unit 701 generates the registration job illustrated in FIG. 13. In S1403, the registration job transmission unit 702 transmits the registration job of FIG. 13 to all the image formation apparatuses 102 selected under the login device name 1300.

Steps S1404 to S1406 are executed by an image formation apparatus 102-1. The image formation apparatus 102-1 refers to a single image formation apparatus 102 that received the registration job in S1403 and in which the registration job has been activated by the registration job execution unit 703.

Step S1404 is equivalent to step S904, and the description thereof is not repeated herein. In S1405, the registration job execution unit 703 newly registers or updates the user information by executing the process flow described in FIG. 12. In S1406, the input/output apparatus 310 displays the user information newly registered or updated in S1405.

In S1407, the user information management unit 408 of the image formation apparatus 102-1 transmits the user information registered in S1405 to one or a plurality of image formation apparatuses 102-2 via the external communication unit 404. Herein, the image formation apparatus 102-2 refers to one or a plurality of image formation apparatuses 102 that have been selected under the login device name 1300 and have received the registration job, but in which the registration job has not been activated.

In S1408, the image formation apparatus 102-2 stores the user information received from the image formation apparatus 102-1 in the secondary storage device 308.

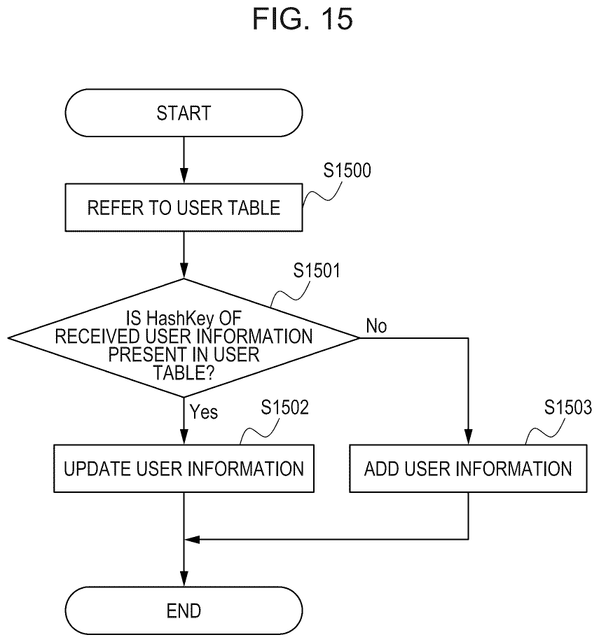

FIG. 15 illustrates a flowchart at a time when the image formation apparatus 102-2 receives user information from the image formation apparatus 102-1 to register the user information according to the fifth embodiment.

In S1500, the user information management unit 408 of the image formation apparatus 102-2 refers to the secondary storage device 308 to obtain the user table of Table 2.

In S1501, the user information management unit 408 of the image formation apparatus 102-2 determines whether the value in the “HashKey” column of the user information received in S1406 is included in the “HashKey” column in the user table. When it is determined that the value is included, the flowchart transitions to step S1502. When it is determined that the value is not included, the flowchart transitions to step S1503.

In S1502, the user information management unit 408 of the image formation apparatus 102-2 updates the user information to store the updated user information in the secondary storage device 308. Specifically, the user information management unit 408 of the image formation apparatus 102-2 replaces the value in the “user ID” column of the registered user information with the value in the “user ID” column of the received user information.

In S1503, the user information management unit 408 of the image formation apparatus 102-2 adds user information to store the user information in the secondary storage device 308. Specifically, the user information management unit 408 of the image formation apparatus 102-2 stores the user information received in S1406 in the secondary storage device 308 as is.

As described above, based on the registration job in FIG. 13, the sequence diagram in FIG. 14, and the flowchart in FIG. 15, it is possible to register the user information for the plurality of image formation apparatuses 102. The content of the user information of the same person can be synchronized between the plurality of image formation apparatuses 102.

As described above, according to the present embodiment, in a case where the plurality of image formation apparatuses 102 are present, the user registration operational burden on the administrator of the image formation apparatuses 102 can be reduced. In addition, it is possible to remove the risk of confusing the administrator of the image formation apparatuses 102 because of the difference in the content of the user information of the same person between the plurality of image formation apparatuses 102.

### Sixth Embodiment

The second embodiment introduces the job for activating the process flow described in FIG. 5, and the registration operation of the user information is performed by the person who desires to use the image formation apparatus 102.

In the second embodiment, the administrator of the image formation apparatus 102 performs the operation of granting the authority for using the function of the image formation apparatus 102 to each user information the same number of times as the number of users who are registered in the image formation apparatus 102, which may result in an increase in the work of the administrator.

According to the present embodiment, the authority for using the function of the image formation apparatus 102 is granted to the user information based on the registration job activation password 802 set in the registration job.

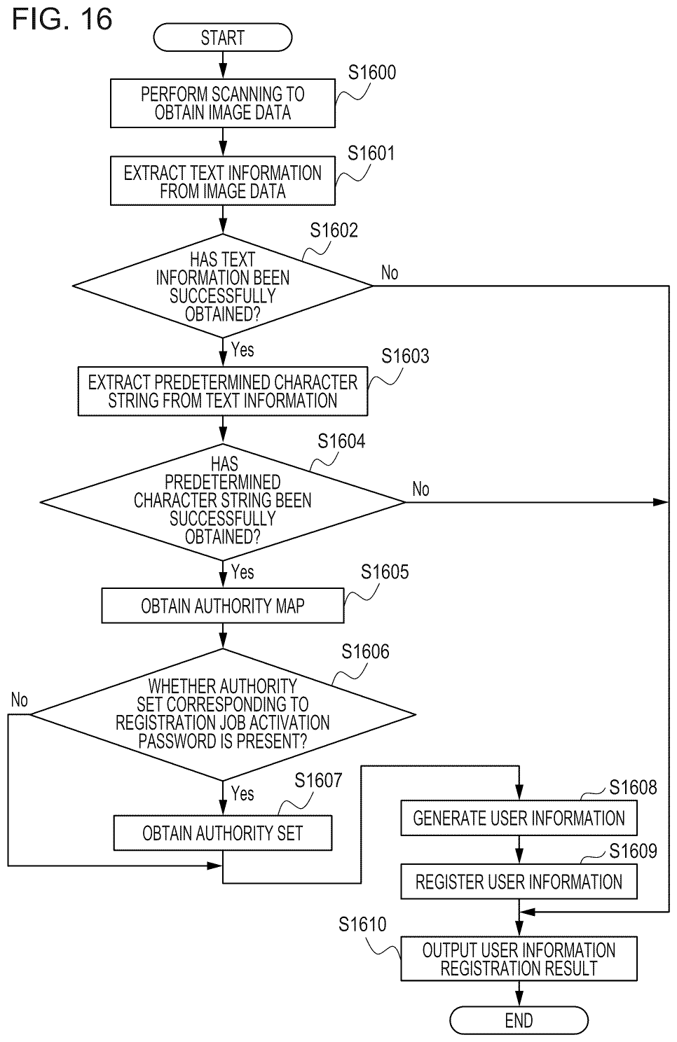

FIG. 16 illustrates a flowchart in the user information registration processing of the present embodiment.

A realization method and a start condition for the flowchart in FIG. 16 are similar to those for the flowchart in FIG. 5, and the description thereof is not repeated herein. Steps S1600 to S1604 are equivalent to steps S500 to S504, and the description thereof is not repeated herein.

In S1605, the user information generation unit 703-4 obtains, from the user information management unit 408, an authority map in which a necessary authority to use the function of the image formation apparatus 102 corresponding to the registration job activation password 802 is stored. An example of the authority map is illustrated in Table 4.

TABLE 4
Authority map

| Authority setting | Password |
|---|---|
| Printing: permitted, copying: permitted, boxing: | 1111 |
| permitted, scanning: permitted | |
| Printing: not permitted, copying: not permitted, | 0000 |
| boxing: not permitted, scanning: not permitted | |

An “authority setting” column is a column for storing a necessary authority to use the function of the image formation apparatus 102 as a built-in set value.

“Password” column is a column for storing a password to be set as the registration job activation password 802. In S1606, the user information generation unit 703-4 determines whether the password that has been set as the registration job activation password 802 is present in the “password” column of the authority map in Table 4. When it is determined that the password is present, the flowchart transitions to step S1607. When it is determined that the password is not present, the flowchart transitions to step S1608.

In S1607, the user information generation unit 703-4 obtains an authority setting corresponding to the registration job activation password 802 from the authority map in Table 4. For example, in a case where “1111” is set as the registration job activation password 802, the user information generation unit 703-4 obtains an authority setting in which the use of all of printing, copying, boxing, and scanning is permitted.

In S1608, the user information generation unit 703-4 generates user information with an authority setting by using the first character string and the second character string extracted in S1503, and also the authority setting obtained in S1607. An example of the user information with authority setting is illustrated in Table 5. “1111” is set as the registration job activation password.

TABLE 5
User information with authority setting

| User ID | Password | Authority setting |
|---|---|---|
| Shimomaruko | 110100197810270022 | Printing: permitted, |
| Taro | | copying: permitted, boxing: |
| | | permitted, scanning: |
| | | permitted |

The “user ID” column and the “password” column are equivalent to the “user ID” column and the “password” column of the user information in Table 1, and the description thereof is not repeated herein.

The “authority setting” column is a column for storing the authority setting obtained in S1607. In a case where the process flow directly transitions from S1606 to S1608, a value in the “authority setting” column is empty.

In S1609, the user information generation unit 703-4 stores, in the secondary storage device 308, the user information with authority setting in Table 5 that is generated in S1608. In S1610, the input/output apparatus 310 displays all the columns of the user information with authority setting in Table 5 that is generated in S1608 and the value in each of the columns.

As described above, based on the flowchart in FIG. 15, the user information granted with the authority to use the function of the image formation apparatus 102 can be generated.

As described above, according to the present embodiment, it is possible to reduce the operational burden on the administrator of the image formation apparatus 102 when the authority is granted to the user information.

### OTHER EMBODIMENTS

The present disclosure can also be realized by processing in which a program for realizing one or more functions of the above-described embodiments is supplied to a system or an apparatus via a network or a storage medium, and one or more processors in a computer of the system or the apparatus read out and execute the program. The present disclosure can be realized by a circuit configured to realize one or more function (for example, an application specific integrated circuit (ASIC)).

The disclosure of the above-described embodiments includes the following configurations.

Configuration 1. An image formation apparatus including:
a reading unit configured to read a sheet on which a character string is printed; and
a memory storing a program and a processor, that when executing the program, is configured to extract the character string from the sheet read by the reading unit, to generate, based on the character string extracted by the extraction unit, login information for logging into the image formation apparatus; and to register the login information generated by the generation unit.

Configuration 2. The image formation apparatus according to Configuration 1, the processor further configured to log into the image formation apparatus based on the registered login information.

Configuration 3. The image formation apparatus according to Configuration 2, further including a printing unit configured to print an image associated with a user who has logged in.

Configuration 4. The image formation apparatus according to Configuration 1, in which the character string is personal information.

Configuration 5. The image formation apparatus according to Configuration 1, in which the sheet is an identification certificate.

Configuration 6. The image formation apparatus according to Configuration 1, the processor further configured to update, in a state in which the login information has been registered, in a case where the login information is generated, the registered login information to the generated login information.

Configuration 7. The image formation apparatus according to Configuration 1, in which the login information includes user information and a password.

Configuration 8. A method for an image formation apparatus, the method including:
reading a sheet on which a character string is printed;
extracting the character string from the read sheet;
generating, based on the extracted character string, login information for logging into the image formation apparatus; and
registering the generated login information.

Configuration 9. The method according to Configuration 8, further including logging into the image formation apparatus based on the registered login information.

Configuration 10. The method according to Configuration 9, further including printing an image associated with a logged in user.

Configuration 11. The method according to Configuration 8, in which the character string is personal information.

Configuration 12. The method according to Configuration 8, in which the sheet is an identification certificate.

Configuration 13. The method according to Configuration 8, further including updating, in a state in which the login information has been registered, in a case where the login information is generated, the registered login information to the generated login information.

Configuration 14. The method according to Configuration 8, in which the login information includes user information and a password.

Configuration 15. A non-transitory computer-readable recording medium recording a program for causing a computer to execute a method for an image formation apparatus, the method including:
reading a sheet on which a character string is printed;
extracting the character string from the read sheet;
generating, based on the extracted character string, login information for logging into the image formation apparatus; and
registering the generated login information.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-035727, filed Mar. 8, 2024, which is hereby incorporated by reference herein in its entirety.

What is claimed is:

1. An image formation apparatus comprising:
a reading unit configured to read a sheet on which a character string is printed; and
a memory storing a program and a processor, when executing the program, configured to:
extract the character string from the read sheet,
generate, based on the extracted character string, login information for logging into the image formation apparatus, and
register the generated login information.

2. The image formation apparatus according to claim 1, wherein the processor is further configured to enable a login into the image formation apparatus based on the registered login information.

3. The image formation apparatus according to claim 2, further comprising a printing unit configured to print an image associated with a logged in user.

4. The image formation apparatus according to claim 1, wherein the character string is personal information.

5. The image formation apparatus according to claim 1, wherein the sheet is an identification certificate.

6. The image formation apparatus according to claim 1, wherein the processor is further configured to update, in a state in which the login information has been registered, in a case where the login information is generated, the registered login information to the generated login information.

7. The image formation apparatus according to claim 1, wherein the login information includes user information and a password.

8. A method for an image formation apparatus, the method comprising:
reading a sheet on which a character string is printed;
extracting the character string from the read sheet;
generating, based on the extracted character string, login information for logging into the image formation apparatus; and
registering the generated login information.

9. The method according to claim 8, further comprising logging into the image formation apparatus based on the registered login information.

10. The method according to claim 9, further comprising printing an image associated with a logged in user.

11. The method according to claim 8, wherein the character string is personal information.

12. The method according to claim 8, wherein the sheet is an identification certificate.

13. The method according to claim 8, further comprising updating, in a state in which the login information has been registered, in a case where the login information is generated, the registered login information to the generated login information.

14. The method according to claim 8, wherein the login information includes user information and a password.

15. A non-transitory computer-readable recording medium recording a program for causing a computer to execute a method for an image formation apparatus, the method comprising:
reading a sheet on which a character string is printed;
extracting the character string from the read sheet;
generating, based on the extracted character string, login information for logging into the image formation apparatus; and
registering the generated login information.
